(19) United States
(12) Patent Application Publication
(10) Pub. No.: US 2009/0273610 A1
(43) Pub. Date: Nov. 5, 2009

(54) VIRTUAL LESION QUANTIFICATION

(75) Inventors: Marc Busch, Aachen (DE); Ralph Brinks, Hagen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 11/913,338

(22) PCT Filed: Apr. 19, 2006
(86) PCT No.: PCT/IB06/51208

§ 371 Date: Nov. 1, 2007

(30) Foreign Application Priority Data
May 3, 2005 (US) 60/677172

(51) Int. Cl. G09G 5/00; G06T 7/00

(52) U.S. Cl. 345/619; 382/128; 382/131; 382/130; 715/810

(57) ABSTRACT

A system and method for quantifying a region of interest in a medical image and in particular, a PET image. The system and method allow the clinician to make real time quantitative analysis of a region of interest. The system and method can be used to quantify small lesions within a region of interest by generating a set of virtual lesions for comparison with the actual lesion. Quantitative information, such as lesion size and tracer activity, or SUV, can be obtained to assist the clinician or physician in the diagnosis and treatment of the lesion.

Reliable quantification of functional medical images, such as Positron Emission Tomography (PET), is becoming an increasingly important feature for the detection and treatment of medical abnormalities. A PET image is used to provide a clinician or physician information regarding the physiological condition of regions of interest (ROI).

The partial volume effect (PVE) in PET is a problem for quantitative tracer studies as it may lead to misinterpretation of the data collected. The partial volume effect results from the limited spatial resolution of the imaging device, and impairs the ability to distinguish between two points after image reconstruction. The limited resolution of a PET imaging system is the main reason for the PVE, which leads to a decrease of contrast and peak recovery for small objects. The partial volume effect is caused by spillover of radioactivity into neighboring regions and the underlying tissue inhomogeneity of the particular region. The partial volume effect results in a blurring of the data and difficulty in providing quantification of the data. For example, PVE can result in an underestimation of activity or standardized uptake value (SUV) for small lesions.

The two main strategies to solve this problem are voxel-based and region-based deconvolution. The latter, one example being the GTM method, needs additional anatomical information, e.g. from a co-registered CT image. However, this additional information might not always be available. Furthermore, inaccurate registration might introduce new artifacts that limit the benefit of the method. The GTM method therefore relies on accurate input (definition of regions of interest with homogeneous activity concentrations, manual correction of registration errors, etc.) by the clinician.

On the other hand, voxel-based deconvolution, e.g. the iterative RL method, requires no additional input from the clinician, and might therefore be easy to handle. However, the noisy nature of PET images makes deconvolution an ill-posed problem as it seldom produces satisfactory, quantitative results. Iterative algorithms with regularization are needed to prevent noise amplification, making it a time-consuming and error-prone procedure.

The present invention is directed to a system and method for quantifying a region of interest in a medical image, and in particular in a PET image. The system and method allow the clinician to make real time quantitative analysis of a region of interest without requiring anatomical information from a CT image and without a complex iterative algorithm for regularization.

In one embodiment, the system and method are used to quantify small lesions within a region of interest. A set of virtual lesions can be generated and then visually compared to the actual lesion. Quantitative information, such as lesion size and tracer activity, or SUV, can be obtained to assist the clinician or physician in the diagnosis and treatment of the lesion.

In the accompanying drawings, which are incorporated in and constitute a part of this specification, embodiments of the invention are illustrated, which, together with a general description of the invention given above, and the detailed description given below serve to illustrate the principles of this invention. One skilled in the art should realize that these illustrative embodiments are not meant to limit the invention, but merely provide examples incorporating the principles of the invention.

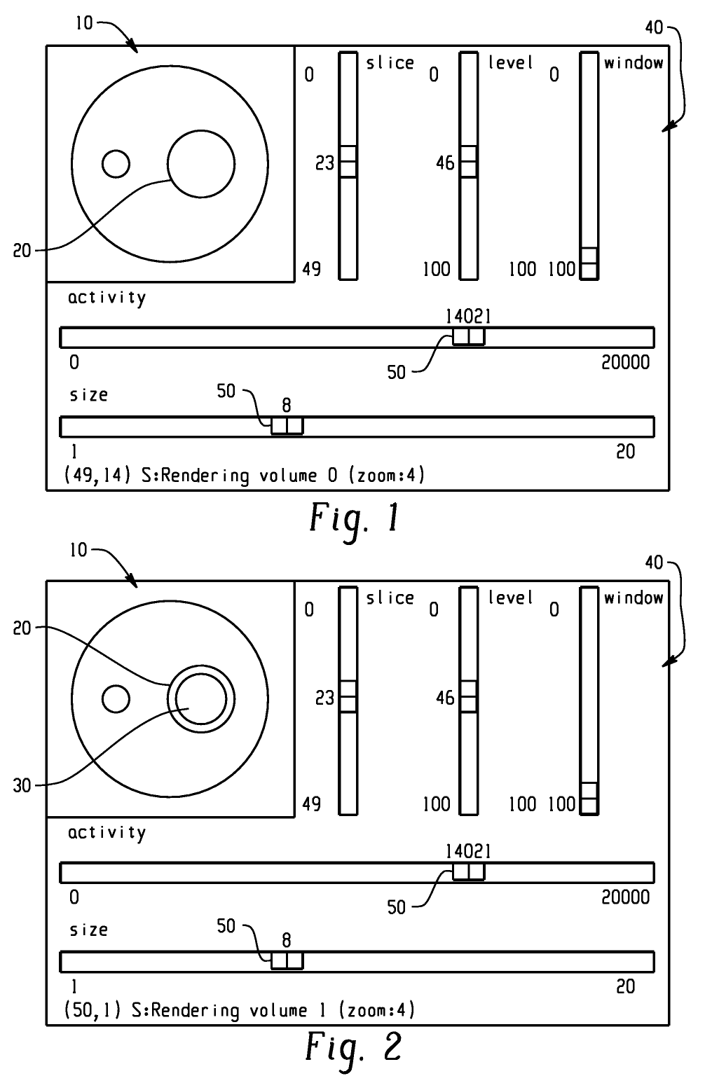

FIG. 1 illustrates a graphical user interface (GUI) that allows scanning through virtual lesions to determine the correct set of variables, such as size and activity.

FIG. 2 illustrates the lesion shown in FIG. 1 with a virtual lesion (not set to the correct parameters) activated in subtraction mode.

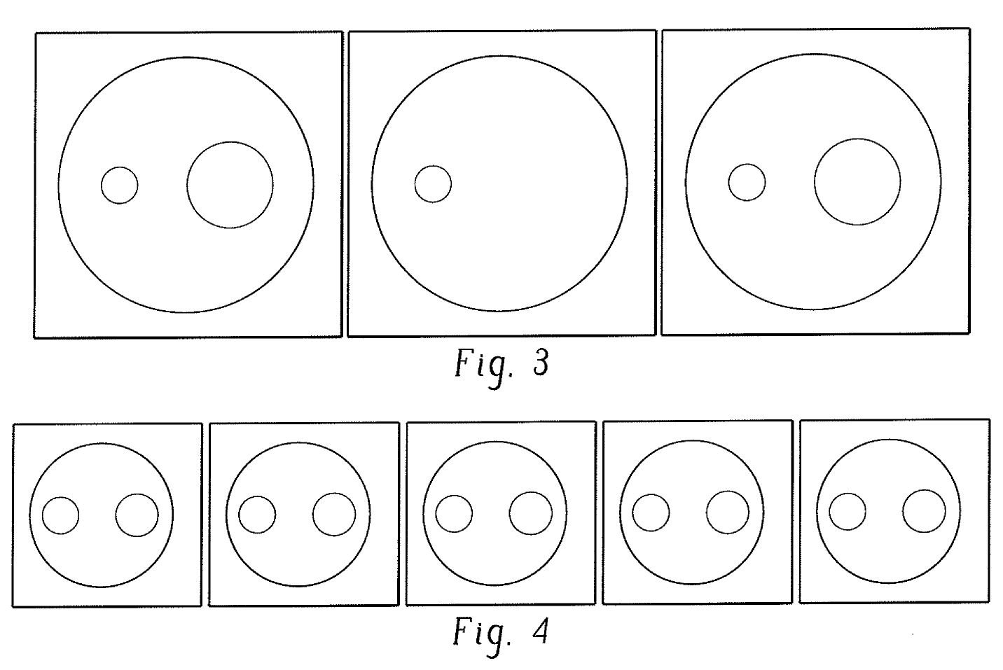

FIG. 3 illustrates a set of images wherein the activity of the virtual lesion is chosen correctly and the size of the virtual lesion is set to 15 mm (left), 16 mm (middle), and 17 mm (right).

FIG. 4 illustrates a set of images wherein the size of the virtual lesion is chosen correctly and the activity of the virtual lesion is set to (from left to right) 90%, 95%, 100%, 105%, and 110% of the correct value.

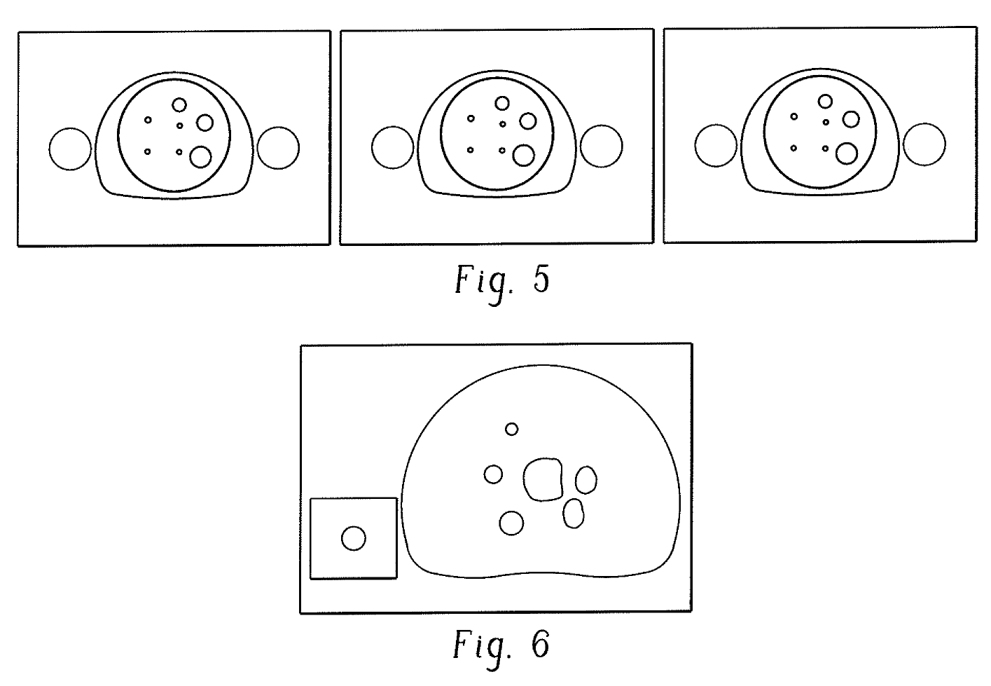

FIG. 5 is a NEMA-IEC Phantom measurement, original (left), virtual lesion subtracted for 22 mm sphere (center), and virtual lesion subtracted for 17 mm sphere (right).

FIG. 6 illustrates a lesion with a virtual lesion in overlay mode.

The system and method of quantitative analysis of PET images provided herein allows the clinician or physician to utilize his or her own knowledge and background to make real time comparisons to allow for quantification of lesions within the region of interest. This approach is particularly helpful in that it provides a quick and simple visual approach to solve quantitative problems, such as, for example, determination of lesion size or lesion SUV.

In one embodiment of the invention, the clinician can easily establish quantitative parameters for lesions, which appear as hot regions in PET images. Once the clinician identifies a lesion, the lesion is compared to a set of computed virtual lesions, which can vary in predetermined parameters such as, for example, size and activity. The clinician can quickly and easily adjust the virtual lesion parameters until the virtual lesion “matches” the lesion in the PET image. By “matching” the virtual lesion to the lesion in the PET image, it is meant that the virtual image and PET image lesion can be visually compared to determine whether the parameters of the virtual lesion are correctly chosen. For example, the virtual lesion may be displayed in subtraction mode or overlay mode. In subtraction mode, best shown in FIG. 2, if the parameters of the virtual lesion are chosen correctly, the subtracted image will produce an image of the region of interest without the lesion. In overlay mode, best shown in FIG. 6, the virtual lesion can be freely positioned over the PET image to determine the virtual lesion parameters. In either mode, it would generally be desirable to maintain the original PET image, and as such the subtracted image or overlay image may be produced as an alternative image or view.

One example of a method that implements the invention is as follows. Software is provided to the clinician that allows implementation of the method in an efficient manner. The software includes an algorithm for modeling the point spread function (PSF) from either simulations or phantom images. The point spread function is used to calculate the set of virtual lesions, as discussed in further detail below.

With reference to FIG. 1, a PET image 10 is acquired for the region of interest that includes one or more lesions 20 to be quantified. The lesion(s) will appear as hot spots 20 in the PET image 10. The clinician focuses on a particular lesion by selecting the lesion. This can be done, for example, by clicking on the hot spot 20 with a mouse cursor or other user input device. The clinician also provides the general geometrical shape of the desired virtual lesions. For example, spherical virtual lesions can be used for most PET oncology studies. Other predetermined shapes can also be used, such as, for example square, triangular or oval. In some cases, the clinician may want to define a particular geometric shape based upon the region of interest or the shape of the lesion or hot spot. The clinician may either enter the desired geometrical shape, or the software can default to a standard shape, such as spherical, which can later be changed if so desired.

Once the center of the hot spot 20 and the desired shape of the virtual lesion have been determined, the software uses the point spread function to calculate a number of simulated images, or virtual lesions, that vary in preselected parameters. For example, a set of virtual lesions can be created with varying sizes or activity. As a specific example, 20 virtual lesions 30 (see FIG. 2) can be generated which vary in diameter in the range of 1 mm to 20 mm, in 1 mm step increments. Generally, different virtual lesions do not need to be calculated to vary the activity of the virtual lesion, since the activity can be determined by multiplying by a factor. It should be obvious to one skilled in the art that additional parameters, such as noise characteristic, can also be incorporated in the point spread function, and thus determined by the virtual lesion, however such additional parameters are typically not needed and often merely complicate the process.

One of the virtual lesions 30 appears in a graphical user interface (GUI) 40, which includes a set of sliders 50 for changing the parameters of the virtual lesion. Other means for changing the parameters of the virtual lesion 30 can also be used, such as, for example, numerical inputs or up/down arrows. The PET image 10 also appears in the GUI 40. As mentioned above, the virtual lesion 30 can appear in subtraction mode, as shown in FIG. 2, or in overlay mode, as shown in FIG. 3. In subtraction mode, the virtual lesion is positioned at the center of the hot spot 20 and the virtual lesion parameters are changed until the hot spot disappears from the subtracted image. In overlay mode, the virtual lesion is produced in a separate window that can be freely moved until it covers the hot spot with the correct size and activity parameters. In either mode, the set of sliders 50 can be adjusted to the correct values to determine the correct virtual lesion parameters. While adjusting the slider to determine the correct virtual lesion size might appear to actually change the size of the virtual lesion 30, the software is actually moving to the next size of virtual lesion generated in the set of virtual lesions. In this regard, movement of the size slider does not require recalculation of a virtual lesion. This provides a seamless display of information and does not require processing time.

The clinician can interactively change the parameters, e.g. radius and activity, of the virtual lesion while he observes the alternative view in real-time. The parameters are continually adjusted until the correct parameters are determined. The result is an accurate estimate of the lesion size as well as the lesion activity or SUV.

The Figures will now be discussed in further detail as they illustrate examples of the method discussed above. FIG. 1 illustrates a cylindrical phantom with two spherical hot spots 20. The spherical hot spots 20 appear blurred as a consequence of the limited resolution of the imaging system. Exact determination of activity and size is therefore difficult.

FIG. 2 demonstrates the use of virtual lesions 30 to determine the activity and size of the hot spots 20. The clinician has marked the large spherical hot spot 20 as the lesion of interest. In this case, the center of the hot spot 20 is automatically determined with sub-voxel accuracy. A set of virtual lesions 30 is calculated at the center position of the hot spot. One of the virtual lesions 30, chosen randomly as the initial virtual lesion, is displayed. FIG. 2 shows the virtual lesion in subtraction mode. The clinician will need to adjust the parameters of the virtual lesion 30 by moving the sliders 50 until the correct parameters are determined. In FIG. 2, the selected value for the size of the virtual lesion 30 is too small. This can be seen in the Figure by the bright ring that surrounds the virtual lesion 30. In addition, the selected value for the activity of the virtual lesion is chosen to large. This can be seen by noticing that the center of the virtual lesion 30 is too dark. The clinician will need to adjust the size and activity of the virtual lesion until the parameters are correct.

FIGS. 3 and 4 further illustrate how the parameters of the virtual lesion can be determined. In FIG. 3, the activity of the virtual lesion has been properly selected and the size of the virtual lesion is varied to determine the correct value. In the image on the left, the size of the virtual lesion is set to 15 mm. In the middle image, the size of the virtual lesion is set to 16 mm. In the image on the right, the size of the virtual image is set to 17 mm. It can be seen that the correct value for the size of the virtual lesion is 16 mm. In the image on the left, the virtual lesion is too small as evidenced by the bright ring around the virtual lesion. In the image of the right, the virtual lesion is too large as evidenced by the dark ring around the virtual lesion.

In FIG. 4, the size of the virtual lesion has been properly selected and the activity of the virtual lesion is varied to determine the correct value. The activity of the virtual lesion is set to, from left to right, 90%, 95%, 100%, 105%, and 110% of the correct value. The two images on the left are below the correct value of the activity of the virtual lesion as evidenced by the relative brightness of the virtual lesion. The two images on the right are above the correct valve of the activity of the virtual lesion as evidenced by the relative darkness of the virtual lesion.

The examples shown in FIGS. 3 and 4 demonstrate fairly simple images, that are so simple that the whole process of parameter adaptation could be easily automated. However, in a real clinical application, the images are much more complicated. As shown in FIG. 5, PET images are typically noisy and may include all kinds of anatomy that is hard to handle correctly with a fully automated algorithm. But for the clinician, it still is a simple task to adapt the parameters interactively and find the correct set of parameters. This is because the clinician has a great deal of knowledge of the images and can relatively easily determine the correct parameters of the virtual lesion.

The method described herein allows for a clinician to quickly and easily determine the parameter values of a virtual lesion, which in turn translate into the physical characteristics of the actual lesion. The speed and accuracy in which the clinician can determine the activity, or SUV, and size of a lesion are dramatically improved over conventional techniques. This is especially true for the notoriously problematic case of small lesions that show a bad contrast recovery due to the limited resolution of the imaging system.

It should be noted that variations of the method discussed above can also be implemented. For example, the parameter determination process, or a portion thereof, can be automated. For instance, the radius of the virtual lesion might be manually determined through an interactive iterative process, while the activity of the virtual lesion is determined with a real-time optimization algorithm. The process can also be modified to account for other effects besides spatial resolution. For example, the point spread function could also account for other parameters, such as noise in the PET image. Furthermore, the method is not intended to be limited to quantification of PET images, but may also be employed in other medical imaging systems, such as SPECT.

The invention is also directed to a system for quantitative analysis of medical images, and has particular application in PET imaging systems. The system employs standard imaging equipment, including one or more detectors, a gantry and a patient table. The system also includes a source of radioactivity that is used to produce an image and a software system for receiving and processing data and producing an image of the source. It should be noted that other imaging systems can be used and that the system described herein is not meant to be limiting.

The system further includes an image quantification improvement component. This component is generally comprised of a software package, which can be incorporated into the standard image acquisition and region of interest software or can be separately implemented. The image quantification improvement software includes a model of the point spread function of the imaging system. Data provided from simulations or phantom images can be used to develop a model of the point spread function. The algorithm is then used to generate a set of virtual lesions once a clinician provides a PET image with a selected region of interest. The set of virtual images generated can be stored in a permanent memory source, or more preferably, in a temporary memory source that can be overwritten when the next set of virtual lesions is generated.

The system further includes a graphical user interface 40, such as the one shown in FIGS. 1 and 2. One skilled in the art should appreciate that the graphical user interface shown in the Figures is merely an illustrative example and that other graphical user interfaces can be used. It is desirable to provide a graphical user interface that provides the data and images in an organized and easily understandable manner and also allows for easy and quick manipulation of one or more parameters. As shown in FIGS. 1 and 2, the graphical user interface 40 includes a combined image, here shown in subtraction mode, of the PET image 10 and virtual lesion 30 and a set of parameter sliders 50 for adjustment of the virtual lesion parameters. The graphical user interface 40 may also show an unaltered view of the PET image and may show the virtual lesion in overlay mode. By moving the sliders 50, or otherwise changing the value of the parameters, the image quantification improvement software either generates a different virtual lesion from the set virtual lesion images at the region of interest or multiplies the current virtual lesion by a factor, thereby changing a parameter, such as activity of the virtual lesion. In either case, manipulation of the sliders 50 allows the clinician to visually compare virtual lesions with different parameters to the actual lesion shown in the PET image. This allows the clinician to determine the correct values of the parameters of the virtual lesion, which in turn provides the physical characteristics of the actual lesion. The system may optionally include a memory source to save the finalized combined image or virtual lesion parameter data or an output source, such as a printer for printing the finalized combined image of virtual lesion parameter data.

The invention has been described with reference to one or more preferred embodiments. Clearly, modifications and alterations will occur to other upon a reading and understanding of this specification. It is intended to include all such modifications and alterations insofar as they come within the scope of the appended claims or equivalents thereof.

1. A system for providing quantitative analysis of medical images, the system comprising:
(a) a system for generating a medical image, said medical image including at least one lesion; and
(b) an image quantification improvement component comprising:
i). a model of the system point spread function which is used to generate a set of virtual lesions at a selected point in the medical image;
ii). a graphical user interface that provides a visual comparison of the medical image with a virtual lesion selected from said set of virtual lesions, wherein said graphical user interface includes one or more parameter adjustment mechanisms that changes the virtual lesion that is visually comparable to the medical image.

2. The system of claim 1, wherein said medical image is a PET image.

3. The system of claim 1, wherein at least one of said parameter adjustment mechanisms selects a different virtual lesion from said set of virtual lesions upon manipulation.

4. The system of claim 1, wherein at least one of said parameter adjustment mechanisms changes the virtual lesion by a factor upon manipulation.

5. The system of claim 1, wherein said set of virtual lesions comprises virtual lesions of different sizes each differing by an incremental value.

6. The system of claim 1, wherein said visual comparison of the medical image with the virtual lesion is a subtracted view.

7. The system of claim 1, wherein said visual comparison of the medical image with the virtual lesion is an overlay view.

8. The system of claim 1, wherein said system for generating a medical image comprises one or more detectors, a gantry, a patient table and a source including a radioactive element.

9. A medical image quantification improvement component comprising:
a means for using a model of the system point spread function to generate a set of virtual lesions at a selected point in a medical images;
a graphical user interface that provides a visual comparison of the medical image with a virtual lesion selected from said set of virtual lesions, wherein said graphical user interface includes one or more parameter adjustment mechanisms that changes the virtual lesion that is visually comparable to the medical image.

10. The system of claim 9, wherein said medical image is a PET image.

11. The system of claim 9, wherein at least one of said parameter adjustment mechanisms selects a different virtual lesion from said set of virtual lesions upon manipulation.

12. The system of claim 9, wherein at least one of said parameter adjustment mechanisms changes the virtual lesion by a factor upon manipulation.

13. The system of claim 9, wherein said set of virtual lesions comprises virtual lesions of different sizes each differing by an incremental value.

14. The system of claim 9, wherein said visual comparison of the medical image with the virtual lesion is a subtracted view.

15. The system of claim 9, wherein said visual comparison of the medical image with the virtual lesion is an overlay view.

16. A method for improving quantitative analysis of medical images, said method comprising the steps of:
deriving a point spread function based on a set of simulations or phantom images;
acquiring a medical image which includes at least one lesion;
determining a region of interest within the medical image;
generating a set of virtual lesions from said point spread function at said region of interest;
generating a comparative view of said medical image and a virtual lesion selected from said set of virtual lesions;
manipulating one or more virtual lesion parameters to change the virtual lesion in the comparative view;
translating said one or more virtual lesion parameters into physical characteristics of said at least one lesion.

17. The method of claim 16, wherein the step of manipulating one or more virtual lesion parameters to change the virtual lesion further comprises selecting a different virtual lesion from said set of virtual lesions upon manipulation of at least one of said one or more virtual lesion parameters.

18. The method of claim 16, wherein the step of generating a comparative view comprises generating a comparative view in subtraction mode.

19. The method of claim 16, wherein the step of generating a comparative view comprises generating a comparative view in overlay mode.

20. The method of claim 16, wherein said set of virtual lesions comprises virtual lesions of different sizes each differing by an incremental value.
